(19) United States
(12) Patent Application Publication
(10) Pub. No.: US 2008/0121567 A1
(43) Pub. Date: May 29, 2008

(54) PROCESS FOR SELECTIVE RECOVERY OF BITUMEN FROM OIL SANDS SLURRIES BY COLUMN FLOTATION

(76) Inventors: David W. LIN, Rossland (CA); Hector M. LIZAMA, Trail (CA)

Correspondence Address: BORDEN LADNER GERVAIS LLP, 1200 WATERFRONT CENTRE, 200 BURRARD ST., P.O. BOX 48600, VANCOUVER, BC, V7X 1T2, omitted

(21) Appl. No.: 11/947,143

(22) Filed: Nov. 29, 2007

Related U.S. Application Data
(60) Provisional application No. 60/861,415, filed on Nov. 29, 2006.

(51) Int. Cl. B03B 1/00

(52) U.S. Cl. 209/5

(57) ABSTRACT

A process is provided for obtaining flotation froth with a predetermined solids content by manipulating the bias of a flotation column. The flotation column is used for the flotation of an oil sands slurry, for example oil sands middlings, where bitumen is separated from mineral particles. Bitumen, which is hydrophobic, adheres to rising air bubbles to make a bitumen concentrate. Solids being mostly hydrophilic, report to the column underflow as flotation tails.

### RELATED APPLICATIONS

This application claims the benefit of U.S. Provisional Application 60/861,415, filed Nov. 29, 2006.

### FIELD OF THE INVENTION

This invention applies to the fields of flotation and bitumen extraction from oil sands.

### BACKGROUND OF THE INVENTION

Conventional oil sands processing consists of vigorous mixing with warm water at 30-50° C. This slurry is fed to a primary separation vessel (PSV) where a bitumen froth product is obtained, along with a tails stream and a middlings stream. The middlings stream contains some bitumen that is normally recovered by froth flotation in columns or mechanical cells [Godard & Cleyle, 2004; Mankowski et al, 1999; Wiwchar et al, 2004; Cleyle & Lee, 2006]. Flotation froth is normally recycled back to the primary separation vessel.

The bitumen froth product from the PSV must meet targeted bitumen and solids contents. Bitumen froth product typically has a bitumen content of 55% and a solids content of 15% [Mankowski et al, 1999]. Clearly, these targets are influenced by the composition of feed material to the PSV, including the recycled flotation froth from the middlings circuit. To date, limited attempts have been made to control the composition of such feeds because they are viewed to be outside operational control.

The current operating practice in oil sands middlings circuits is to maximize bitumen recovery. The problem with this operating philosophy is that solids fines are also recovered with the bitumen in the flotation froth. These fines make their way back to the PSV and can be carried over to bitumen froth product.

### SUMMARY OF THE INVENTION

In the present invention a flotation column is used for the flotation of an oil sands slurry, for example oil sands middlings where bitumen is separated from mineral particles. Bitumen, which is hydrophobic, adheres to rising air bubbles to make a bitumen concentrate (flotation froth). Solids being mostly hydrophilic, report to the column underflow as flotation tails. In particular, the present invention provides a method or a process for obtaining flotation froth with a pre-determined solids content by manipulating the bias of a column cell.

In contrast with conventional operating practise, the method of this invention recovers bitumen within a solids recovery constraint, i.e. solids deportment to the flotation froth is constrainted to be within a predetermined limit. According to one aspect, this is done by maintaining the column bias at or above a predetermined value, such as for example −0.015 cm/s.

Column bias or bias rate is based on water balance and in its simplest form compares water in the concentrate, resulting from the froth flotation, to wash water. Zero bias is when the net difference of water between these streams is zero. In other words, wash water simply replaces the volume of water in the concentrate at zero bias. Positive bias is when wash water exceeds water in the concentrate. The difference can be expressed as volume of water per unit time per unit area of column, or as a superficial velocity. This is particularly important and best visualized at the upper end of the column. An equivalent measure for bias is the net difference of water flow between the tailings resulting from the froth flotation and the feed to the column.

As a close approximation for overall low solids density operations, all slurry stream volumes can be expressed in terms of water volumes or flows, the solids assumed to be negligible. At zero bias, the concentrate (water) flow rate equals the wash water flow rate; and, therefore, the feed (water) flow rate would equal the tails (water) flow rate. It follows that the tails flow rate would exceed feed flow rate for positive bias. For this invention, we compared the difference between the tails slurry rate and the feed slurry rate to calculate bias. Therefore, the bias rate of a flotation column is closely approximated and calculated by subtracting the flow rate of column feed from the flow rate of the column tails. In effect, the bias is a measure of the net downward flow of water at the upper part of the flotation column, measured in volumetric units per cross-sectional area of column over time, typically in cm³ per cm² per second, or cm/s. If the only water fed to a column is that in the column feed, the bias is clearly negative: feed flow is the sum of concentrate and tails flow. If sufficient water is added in the froth water wash, then the bias can be positive: water wash flow equals or exceeds the concentrate flow. For the tests done in relation to this invention, wash water was added as froth underwash. Froth underwash is the introduction of wash water into a column below the bitumen froth layer so that the bitumen bubble aggregates rise through a layer of clean (solids-free) water.

In the process of this invention, the solids deportment from oil sand slurry to flotation bitumen froth is preferably kept below 10% with respect to the feed to the column by maintaining the column bias, for example, at about −0.015 cm/s or higher. Results from test work show that a more negative bias than this value results in very high solids deportments to flotation froth concentrate. This due to the higher net upwards flow of water inside the column carrying suspended solids to the froth and entrainment of solids particles in the froth.

To summarize, the present invention identifies the column bias rate as a key parameter in the separation of solids from bitumen.

According to one aspect of the invention, the objective is to limit solids recovery to the flotation froth to 10% with respect to the feed to the column or less by adjusting the column bias rate.

The preferred practise is to operate a column flotation cell in a manner such that the calculated net overall downward flow of water within the upper part of the column above the feed point (column bias rate) is above about −0.015 cm/s. According to another aspect of the invention, the range of bias rate is between about −0.015 and 0.5 cm/s.

This method is applicable to separation of bitumen from oil sand slurry that is composed of bitumen, mineral solids and water. The method can be applied in secondary recovery where bitumen is recovered from an oil sands middlings stream. The method can also be applied to tertiary recovery, where bitumen is separated from oil sands tailings, such as cyclone overflow.

According to another aspect of the invention, froth underwash is used in the column and the flow rates of feed, wash water as underwash, flotation froth, and flotation tails are adjusted to meet the range of bias rates mentioned above.

According to another aspect of the invention, overhead wash water is used in the column and the flow rates of feed, wash water, flotation froth, and flotation tails are adjusted to meet the range of bias rates mentioned above. Alternatively, wash water may be added in the froth.

The main advantage of this method is that it defines an operational parameter that is relatively easy to adjust and control. Although column bias is a known concept in the metallurgical field, it is novel and new to the oil sands industry. No such method is described in the literature for limiting solids recovery to flotation froth in the recovery of bitumen from oil sands.

Further objects and advantages of the invention will become apparent from the description of preferred embodiments of the invention below.

### BRIEF DESCRIPTION OF THE DRAWINGS

The invention will now be described, by way of examples, with reference to the accompanying drawings, in which:

FIG. 1 is a diagrammatical illustration of the operation of a froth flotation column as applied to the flotation of a oil sands slurry;

FIG. 2 is a simplified process flow diagram illustrating the operation of a demonstration plant for the recovery of bitumen from an oil sand slurry by column flotation;

FIG. 3 is a graphical illustration showing solids recovery (i.e. deportment of solids to flotation froth) in a flotation column as a function of column bias rate;

FIG. 4 is a graphical illustration showing solids recovery as a function of column bias rate in a flotation column not operated under the conditions of the present invention;

FIG. 5 shows plots of bitumen-solids selectivity for different bias ranges in a flotation column; and

FIG. 6 shows a plot of bitumen-solids selectivity for different bias ranges in a flotation column not operated under the conditions of the present invention.

FIGS. 7a and b, respectively, show bitumen and solids recovery to overflow as a function of pulp residence time in a flotation column;

FIG. 8 is an illustration of bitumen flotation selectivity against solids for low-grade and high-grade feeds in a flotation column;

FIGS. 9a and b, respectively, show flotation froth bitumen/solids ratio and bitumen grade as functions of bitumen recovery in a flotation column; and

FIGS. 10a and b, respectively, show bitumen and solids recovery to overflow as a function of pulp residence time in a flotation column not operated under the conditions of the present invention.

### DETAILED DESCRIPTION OF THE PREFERRED EMBODIMENTS

In the following description, certain specific details are set forth in order to provide a thorough understanding of various embodiments of the invention. However, one skilled in the art will understand that the present apparatus/method has additional embodiments, and/or may be practiced without at least some of the details set forth in the following description of preferred embodiment(s). In other instances, well known structures associated with the technology have not been described in detail to avoid unnecessarily obscuring the descriptions of the embodiments of the invention.

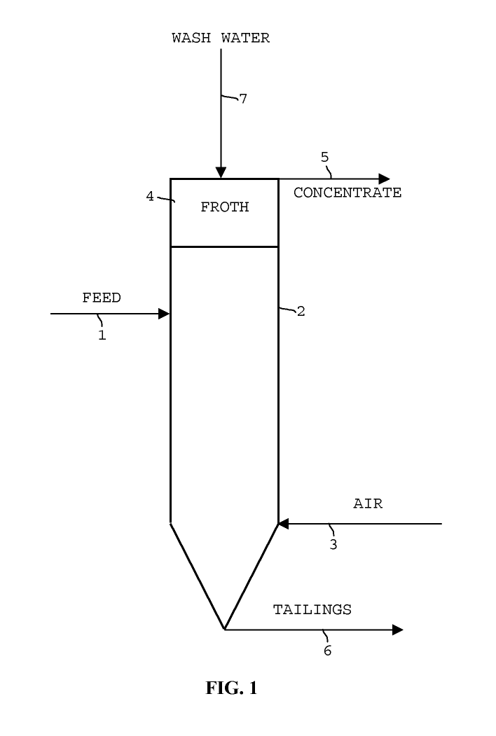

The operation of a flotation column for the flotation of an oil sands slurry for the separation of bitumen from mineral particles is illustrated in FIG. 1. This separation is based on the bitumen and mineral particles having different surface hydrophobicities. Oil sands slurry (feed) 1, flows into the column 2 near, but not at, the top, while air bubbles 3 are forced in near the bottom of the column 2. Hence, there are two carrier phases: air bubbles 3 moving up, and aqueous feed 1 moving down. Bitumen, naturally hydrophobic, adheres to rising air bubbles and forms a froth 4 that overflows 5 to a launder at the top of the column 2. The mineral particles, being hydrophilic, remain in aqueous suspension and flow down and out the bottom of the column 2. The froth 4 that overflows the column, carrying mostly bitumen, is termed flotation concentrate. The underflow pulp 6 carrying mostly undesired mineral, or “gangue”, is termed flotation tails. Wash water 7 is introduced in the column 2, above the froth 4 as overhead wash, or in the froth 4, or below the froth 4 as underwash, as desired.

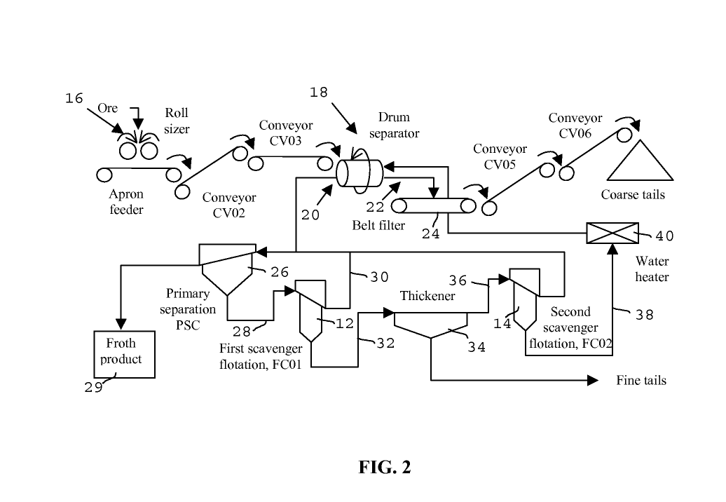

The invention is illustrated by the following example based on a demonstration plant run using the equipment as show in FIG. 2. This plant included, among the various unit operations, two columns 12 and 14 for bitumen flotation. FIG. 2 shows a process flow diagram for the demonstration plant. Oil sands material was passed through a roll sizer 16 and fed to a countercurrent drum separator 18 where it was mixed with warm water. Lean froth containing bitumen overflowed from the ore feed end 20, and wet sand exited at the other end 22. Wet sand exiting the drum 18 was dried in a belt filter 24. Bitumen in the lean froth was separated in a primary separation cell (PSC) 26. PSC overflow was piped to a tank farm 29 for the temporary storage of bitumen froth product. PSC tails 28 were fed to the flotation column 12. Overflow 30 from the column 12 was fed back to the PSC while the underflow 32 was fed to a thickener 34 for water recovery. Thickener overflow 36 was fed to the flotation column 14 for flotation of trace bitumen. Clean water in the underflow 38 of the column 14 was reheated and fed back to the drum separator 18.

Column 12 was a 9.2-m-tall, 2.7-m-diameter (50 m³) SGS Minnovex column with an internal launder. Principal feed to the column was underflow from the PSC. Feed composition varied within the ranges of: 0.01-0.81% bitumen content, 1.5-15.1% solids content, and 84.4-98.3% water content. On occasion, the column 12 operated with froth underwash. Flows ranged from 149 to 215 m³/h for PSC underflow, and 0.8 m³/h for underwash. Forced aeration within the column 12 was in the order of 0.5 cm/s superficial gas velocity (Jg). Gas holdup volume was approximately 10%. The purpose of this column was to recover residual bitumen from PSC tails 28.

Column 14 was a 9.2-m-tall, 2.0-m-diameter (27 m³) SGS Minnovex column with an internal launder. Sole feed to the column was thickener overflow 36, with flows ranging from 107 to 184 m³/h. Feed composition varied in the ranges of: 0-0.33% bitumen content, 0-2.3% solids content, and 97.7-99.9% water content. The column 14 had no froth underwash. Forced aeration within the column was in the order of 0.5 cm/s superficial gas velocity (Jg). Gas holdup volume was approximately 10%. The purpose of column 14 was to remove all residual bitumen from thickener overflow 36 prior to sending the water (column underflow 38) back to the water heater sump 40.

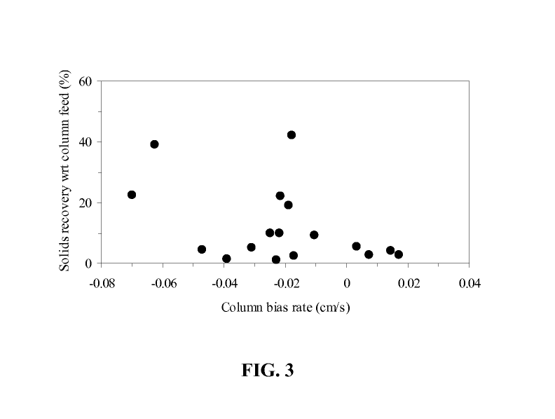

FIG. 3 shows a plot of column bias rate versus solids recovery to froth flotation in the column 12. In this specification solids recovery refers to the amount, proportion or percentage of solids that deports the flotation froth. Note how the solids recovery remains below 10% at column bias rates above −0.015 cm/s. At bias rates lower than −0.015 cm/s, the solids recovery increases, sometimes exceeding 40%.

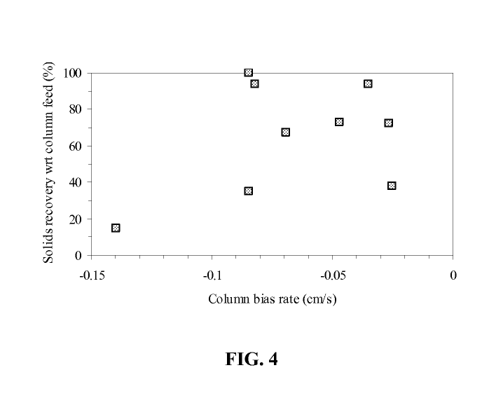

FIG. 4 shows a plot of column bias rate versus solids deportment to froth flotation in the column 14. This column was operated with no froth underwash and with a minimum froth depth. Hence, the bias rate was more negative than for column 12 and never surpassed −0.025 cm/s. Note that the solids recovery was consistently above 10% and sometimes reached 100%.

The operating ranges recommended are a bias rate of −0.015 cm/s or higher. Within this range, rates between −0.015 and 0.5 cm/s are preferred. Bias rates above 0.5 cm/s require substantial wash water or froth underwash flow rates that may not be practical. In effect, a range of −0.015 to 0.05 cm/s is deemed sufficient to limit solids recovery within the 10% value. Optimal bias rate will vary with various feed materials and other solids recovery levels can be selected as desired.

The forced aeration rate of the flotation column 12, 14 should be maintained such that the superficial gas velocity within the column falls in a range of 0.2 to 3.0 cm/s.

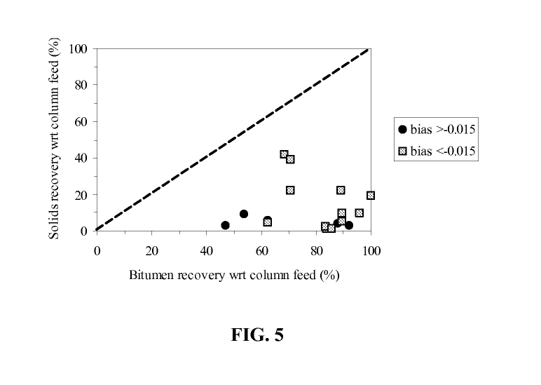

FIG. 5 shows plots of solids recovery as a function of bitumen recovery for cases where the bias rates were above or below −0.015 cm/s in column 12. These bitumen-solids selectivity plots help to gauge and compare bitumen-solids separation efficiencies. The diagonal line represents no separation, i.e. equal recoveries of bitumen and solids. Both data sets lie below the diagonal line, indicating that there was separation, i.e. bitumen recovery to flotation froth concentrate was greater than solids recovery. The higher bias (>−0.015 cm/s) data set is further below the line than the lower bias (<−0.015 cm/s) data set, indicating higher flotation selectivity and therefore higher degree of separation at bias rates greater than −0.015 cm/s.

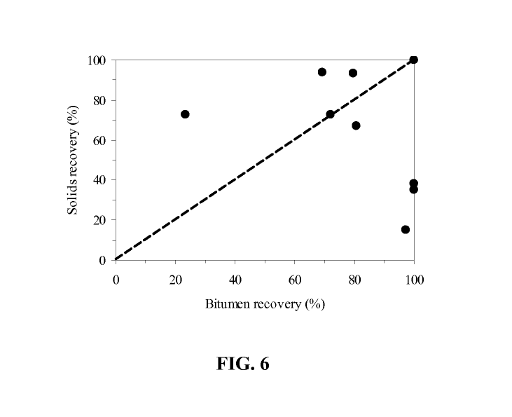

In effect, the higher bias gave higher quality flotation products. In general, bitumen froth quality is based on the bitumen-solids ratio. This is analogous to the grade recovery relationships used in mineral processing. FIG. 6 shows grade-recovery plots for the different bias rates in the flotation froth concentrate of the column 14.

Column 14 was operated with bias rates below the ranges recommended by this invention. Indeed, the bitumen-solids selectivity plot shown in FIG. 6 indicates that there was little separation between bitumen and solids; namely, the data points fall on both sides of the equidistant line.

Column 14 was operated at low bias rates because its primary purpose was to recycle bitumen-free water to the water heater 40. Hence, the lack of bitumen-solids separation was inconsequential. Column 14 was run with a minimum froth depth. The flotation froth concentrate carried large amounts of solids as well as bitumen.

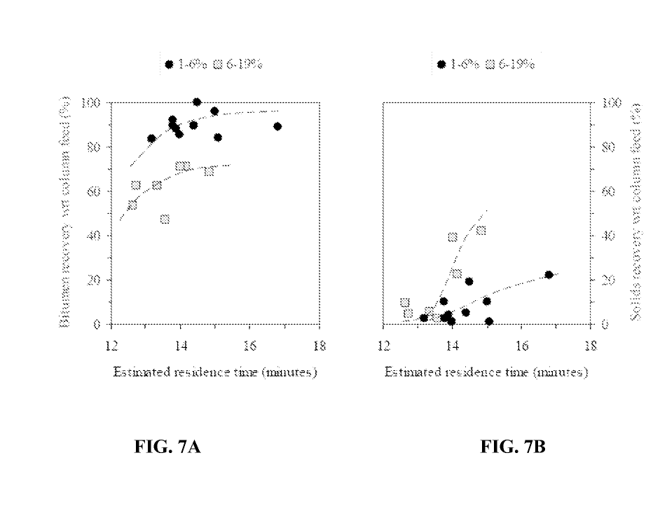

FIGS. 7a and b show the flotation kinetics for bitumen and solids, respectively. In this specification, recovery is defined as the portion of bitumen (or solids) fed to the column 12 that reported to concentrate (or overflow) 30. Recoveries to overflow 30 are plotted against estimated pulp residence times in the column 12. The pulp residence times are estimates based on pulp flows because no residence time distribution tracer tests were done. Pulp residence time estimates assumed a gas holdup volume of 10% based on pulp flow velocities approximating 1 cm/s, thus giving an effective pulp volume of 45 m³ inside the column 12. Two sets of data are shown in FIGS. 7a and b: one set corresponds to feed bitumen grades of 1-6% and another corresponding to feed bitumen grades of 6-19%. It is to be noted that bitumen grades and bitumen contents are not the same. These terms are defined as follows:

$$\begin{matrix}\text{content} = \frac{\text{bitumen}}{\text{bitumen} + \text{solids} + \text{water}} \times 100 \% & ( 1 ) \\ \text{grade} = \frac{\text{bitumen}}{\text{bitumen} + \text{solids}} \times 100 \% & ( 2 )\end{matrix}$$

The reason for considering grade as defined in Equation 2 is based on the concept that water is a carrier phase in column flotation. Separation is based on the differential hydrophobicity of particles (be they solids or bitumen) and their subsequent attachment to air bubbles. Hence, only bitumen droplets and solid particles participate in the separation. In mineral processing terminology, grade is defined as the desired mineral divided by the desired mineral plus gangue, or impurities. When that definition is applied to bitumen flotation, the solids are the obvious impurities.

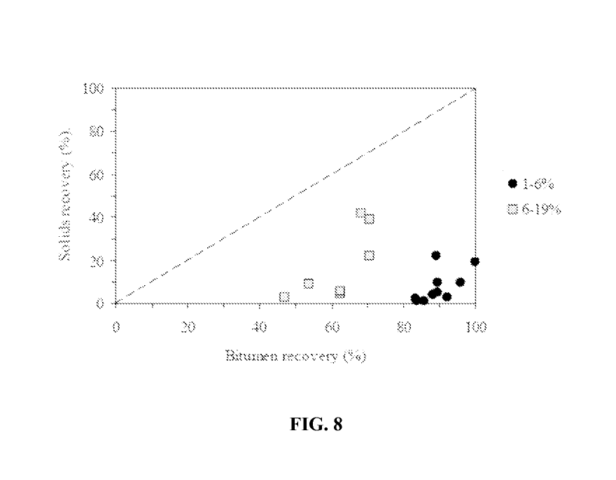

FIGS. 7a and b shows that the difference between bitumen and solids recovery at a given residence time was greater (more effective separation) in the low grade feeds (1-6%), than in the high grade feeds (6-19%). Although in both cases bitumen floated much faster than the solids, bitumen recoveries were higher with lower grade feeds. Solids deportment to concentrate was faster in the high grade feeds than the low grade feeds. Another method to gauge and compare separation efficiencies is to draw bitumen/solids selectivity plots, as shown in FIG. 8.

FIG. 8 shows plots of solids recovery as a function of bitumen recovery. The diagonal line represents no separation, i.e. equal recoveries of bitumen and solids. Both data sets lie below this line, indicating that there was separation, i.e. bitumen recovery to overflow was greater than solids recovery. The low grade data set is further below the line than the high grade data set, indicating higher flotation selectivity and therefore higher degree of separation at lower feed grades. In effect, the lower grade feeds gave higher quality flotation products. In general, bitumen froth quality is based on the bitumen/solids ratio. This is analogous to the grade recovery relationships used in mineral processing.

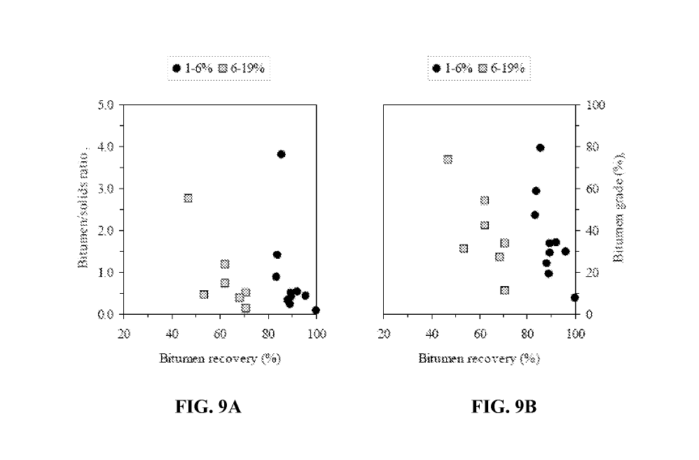

FIGS. 9a and b, respectively, show bitumen/solids curves and grade recovery curves for column 12 flotation froth. It can be seen that the charts in FIGS. 9a and b are virtually identical. They both illustrate the trade-off relationship between recovery and product quality. As more bitumen is recovered, froth quality necessarily decreases. An extreme example of this is that 100% bitumen recovery would be achieved by simply having 100% of the column feed going to overflow (no separation). The grade recovery curve (or ratio recovery curve) allows the operation of a column for optimal recovery and froth quality. For example, according to FIGS. 9a and b, if a 60% bitumen grade (bitumen/solids ratio of 1.5) were desired, the column 12 would have had to be operated such that the bitumen recovery were about 84% for low grade feeds and about 60% for high grade feeds. According to FIGS. 7a and b, this would have been achievable by having a pulp residence time of 13.5 minutes for low grade feeds, and 13 minutes for high grade feeds.

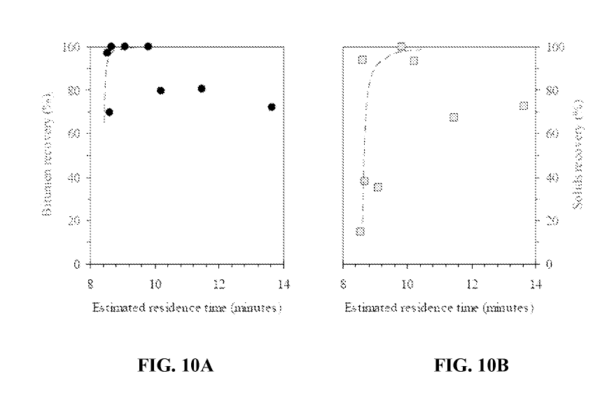

FIGS. 10a and b, respectively, show the flotation kinetics for bitumen and solids in column 14. Recoveries to overflow are plotted against estimated pulp residence times in the column. Pulp residence times were estimated assuming a gas holdup volume of 10%. The data shown in FIGS. 10a and b correspond to feed bitumen grades that were between 8 and 63%.

FIGS. 10a and b show that bitumen and solids had nearly identical flotation kinetics in column 14. Indeed, as already mentioned, the bitumen versus solids recovery data shown in FIG. 6 indicates that there was no flotation selectivity between bitumen and solids. The data points fall on both sides of the line of no separation.

Bitumen/solids separation took place in the first scavenger flotation column 12 but not in the second scavenger flotation column 14. This was likely due, in part, to the feed compositions in the two columns (see Table 1). Compared to column 12, the feed to column 14 had very little solids, almost all of it fines (<44 μm). These fines would have been entrained and carried with froth water to the bitumen froth concentrate. Note that the error values in Table 1 represent 2σ from the mean values.

TABLE 1
Feed composition of column feeds

| | Column 12 | Column 12 | |
|---|---|---|---|
| | (low grade) | (high grade) | Column 14 |
| Bitumen grade, % | 3.1 ± 3.4 | 10.4 ± 9.6 | 36.7 ± 42.5 |
| Solids content, % | 7.1 ± 8.2 | 6.6 ± 8.3 | 0.6 ± 1.7 |
| Fines in solids (<44 μm), % | 63.8 ± 35.9 | 58.6 ± 41.2 | 93.8 ± 17.6 |

The lack of bitumen/solids separation in column 14 was inconsequential to the plant because the purpose of column 14 was to scavenge bitumen from recycle process water prior to heating. That was in contrast to column 12, where efficient bitumen/solids separation was necessary.

Column flotation froth proved very unstable, with violent bubble bursting and bitumen splashing if a froth layer was allowed to form at the top of the columns 12 and 14. To overcome this problem, the columns 12, 14 were run with minimal froth depths. The froth instability may be explained by the operating temperatures that ranged between 50 and 60° C. for both columns. At these temperatures, the decreased surface tension of water promotes bubble coalescence, resulting in very large bubbles. Operating the columns 12, 14 as scavengers resulted in increased carryover of water to the bitumen froth concentrate.

One operational difference between the columns 12 and 14 was that froth underwash was used in column 12 but not in column 14. This meant that column 14 always ran with a negative bias while column 12 sometimes ran with a positive bias, depending on flows. As mentioned, bias refers to the net downward flow of water through the flotation froth. When underwash flow is sufficiently high that the column underflow is higher than the feed flow, then the column is said to run with a positive bias.

A number of common flotation parameters were not measured in the tests. These include froth velocity and lip carrying capacity; pulp residence time distribution for detection of short-circuiting; gas dispersion and holdup; bubble size; and bubble surface area flux to determine carrying capacity.

To summarize, the following conclusions can be drawn from the tests:

Bitumen/solids separation in column 12 was successful at 50-60° C., with feeds having bitumen grades between 1 and 19%, and where the solids had about 60% fines. Bitumen/solids separation did not occur in column 14 at 50-60° C., with feeds having bitumen grades between 8 and 63%, and where the solids had about 90% fines. The lack of separation was likely due to high solids entrainment in the flotation froth.

Bitumen column flotation data can be analyzed and interpreted by adopting mineral processing principles. Flotation kinetics can be deduced by plotting bitumen or solids recovery as functions of residence time. Flotation performance can be evaluated and predicted by plotting bitumen grade (or bitumen/solids ratio) as a function of bitumen recovery. Bitumen/solids separation (or selectivity) can be evaluated and predicted by plotting solids recovery as a function of bitumen recovery. Interpretation of bitumen flotation data becomes very straightforward when bitumen grade is described only in terms of bitumen content and solids content, with the water portion being excluded. Water can be considered simply as a carrier phase. These same mineral processing principles used for column cells are also applicable to bitumen flotation in mechanical cells.

Unless the context requires otherwise, throughout the specification and claims which follow, the word “comprise” and variations thereof, such as “comprises” and “comprising” are to be construed in an open, inclusive sense, that is as “including but not limited to.”

The claims that follow are to be considered an integral part of the present disclosure. Although certain preferred embodiments of the present invention have been shown and described in detail, it should be understood that various changes and modifications may be made therein without departing from the scope of the appended claims. In general, in the following claims, the terms used should not be construed to limit the invention to the specific embodiments disclosed in the specification, but should be construed to include all methods and apparatuses that operate in accordance with the claims. Accordingly, the invention is not limited by the disclosure, but instead its scope is to be determined entirely by the following claims.

We claim:

1. A process for the recovery of bitumen from an oil sand slurry, comprising bitumen, mineral solids and water, by subjecting the slurry to flotation in a flotation column to produce a flotation bitumen froth with a predetermined solids content, resulting from solids deportment from the slurry to the froth, wherein said predetermined solids content is obtained by selectively controlling column bias, the column bias being defined as flow rate of tailings from the column minus flow rate of slurry feed to the column.

2. The process of claim 1, wherein the solids content is maintained at a value of 10% by weight or less.

3. The process of claim 1, wherein the column bias is maintained at a value of at least about −0.015 cm/s.

4. The process of claim 3, wherein the column bias is maintained at a value of about −0.015 cm/s to about 0.5 cm/s.

5. The process of claim 1, wherein the column bias is controlled by operating the flotation column in a manner such that the net overall downward flow of water within an upper part of the column at a location above a feed point of the slurry to the column is above about −0.015 cm/s.

6. The process of claim 1, wherein the slurry is obtained from an oil sands primary, middlings or tailings stream.

7. The process of claim 6, wherein the slurry is obtained from an oil sands tailings cyclone overflow.

8. The process of claim 1, wherein wash water is applied above the froth as overhead wash water, or in the froth, or below the forth as underwash.

9. The process of claim 8, wherein flow rates of slurry feed to the column, wash water, flotation froth and flotation tails are adjusted to control the column bias.

10. A process for the recovery of bitumen from an oil sand slurry, comprising bitumen, mineral solids and water, by subjecting the slurry to flotation in a flotation column to produce a flotation bitumen froth with a predetermined solids content, resulting from solids deportment from the slurry to the froth, wherein said predetermined solids content is obtained by operating the flotation column in a manner such that the net overall downward flow of water within an upper part of the column at a location above a feed point of the slurry to the column is above about −0.015 cm/s.

11. The process of claim 10, wherein the solids content is maintained at a value of 10% by weight or less.

12. A process for the recovery of bitumen from an oil sand slurry, comprising bitumen, mineral solids and water, by subjecting the slurry to flotation in a flotation column to produce a flotation bitumen froth with a predetermined solids content, resulting from solids deportment from the slurry to the froth, wherein said predetermined solids content is obtained by selectively controlling column bias, the column bias being defined as flow rate of wash water to the column minus flow rate of water in the bitumen froth from the column.

13. The process of claim 12, wherein the solids content is maintained at a value of 10% by weight or less.

14. The process of claim 12, wherein the column bias is maintained at a value of at least about −0.015 cm/s.

15. The process of claim 14, wherein the column bias is maintained at a value of about −0.015 cm/s to about 0.5 cm/s.

16. The process of claim 12, wherein the column bias is controlled by operating the flotation column in a manner such that the net overall downward flow of water within an upper part of the column at a location above a feed point of the slurry to the column is above about −0.015 cm/s.

17. The process of claim 12, wherein the slurry is obtained from an oil sands middlings stream.

18. The process of claim 12, wherein the slurry is obtained from an oil sands tailings cyclone overflow.

19. The process of claim 12, wherein froth underwash is applied in the flotation column and wherein flow rates of slurry feed to the column, underwash, flotation froth and flotation tails are adjusted to control the column bias.

20. The process of claim 12, wherein overhead wash water is used in the column and wherein flow rates of slurry feed to the column, wash water, flotation froth and flotation tails are adjusted to control the column bias.
